(19) United States
(12) Patent Application Publication
(10) Pub. No.: US 2014/0075957 A1
(43) Pub. Date: Mar. 20, 2014

(54) FORMED GUSSETS FOR BRACKETS ON GAS TURBINE ENGINES

(71) Applicant: UNITED TECHNOLOGIES CORPORATION, Harford, CT (US)

(72) Inventor: James K. Boehne, Wethersfield, CT (US)

(73) Assignee: UNITED TECHNOLOGIES CORPORATION, Harford, CT (US)

(21) Appl. No.: 13/623,142

(22) Filed: Sep. 20, 2012

(51) Int. Cl. F02C 7/20

(52) U.S. Cl. 60/797

(57) ABSTRACT

Disclosed is a bracket mount assembly for use in a gas turbine engine. The bracket mount assembly includes a communicating member, a mount, and a bracket. The bracket is supported by a static engine structure, and is mounted to the communicating member by way of the mount. Further, the bracket includes a first wall and a second wall, as well as a bend positioned there between, and the bend includes a gusset. The gusset provides a depression in the bend. The gusset and the bracket are made from a single piece of metal.

### BACKGROUND

This application relates to formed metal gussets in gas turbine engines.

Gussets are used to stiffen connections in brackets. For example, one known bracket assembly includes a bracket made of one piece of material, and a gusset made of another piece of material, with the gusset positioned between adjacent faces of the bracket. Another known bracket includes a bracket assembly comprising a bracket having a gusset, and being integrally formed of a composite material.

### SUMMARY

A bracket mount assembly for use in a gas turbine engine according to one embodiment of the present disclosure includes a communicating member, a mount, and a bracket. The bracket is to be supported by a static engine structure, and is mounted to the communicating member by way of the mount. The bracket includes a first wall and a second wall, as well as a bend between the first wall and the second wall. The bend includes a gusset providing a depression in the bend. The gusset and the bracket are made from a single piece of metal.

In a further non-limiting embodiment of the present disclosure, the first wall includes openings, and wherein fastening members are provided through the openings to support the bracket relative the bracket.

In a further non-limiting embodiment of the present disclosure, the mount is attached to the upper surface of the first wall.

In a further non-limiting embodiment of the present disclosure, the gusset further provides the depression in an inner face first wall and an inner face second wall.

In a further non-limiting embodiment of the present disclosure, the static engine structure is parallel to the second wall.

In a further non-limiting embodiment of the present disclosure, the gusset further provides a corresponding projection in an outer face first wall and an outer face second wall.

In a further non-limiting embodiment of the present disclosure, the communicating member is a wire.

In a further non-limiting embodiment of the present disclosure, the communicating member is one of a fluid tube, a valve, and a sensor.

In a further non-limiting embodiment of the present disclosure, the communicating member is attached by use of a captive nut plate.

In a further non-limiting embodiment of the present disclosure, the gusset is stamped into the bracket.

A gas turbine engine according to another embodiment of the present disclosure includes a communicating member, a mount, a static engine structure, and a bracket. The bracket is supported by the static engine structure, and the communicating member mounted to the bracket by way of the mount. The bracket includes a first wall and a second wall, as well as a bend between the first wall and the second wall. The bend includes a gusset, and the gusset provides a depression in the bend. The gusset and the bracket are made from a single piece of metal.

In a further non-limiting embodiment of the present disclosure, the first wall includes openings, and wherein fastening members are provided through the openings to support the bracket relative the bracket.

In a further non-limiting embodiment of the present disclosure, the mount is attached to the upper surface of the first wall.

In a further non-limiting embodiment of the present disclosure, the static engine structure is parallel to the second wall.

In a further non-limiting embodiment of the present disclosure, the formation of the gusset provides the depression in an inner face first wall and an inner face second wall.

In a further non-limiting embodiment of the present disclosure, the formation of the gusset further provides a corresponding projection in an outer face first wall and an outer face second wall.

In a further non-limiting embodiment of the present disclosure, the communicating member is a wire.

In a further non-limiting embodiment of the present disclosure, the communicating member is one of a fluid tube, a valve, and a sensor.

In a further non-limiting embodiment of the present disclosure, the mount is a captive nut plate.

In a further non-limiting embodiment of the present disclosure, the gusset is stamped into the bracket.

These and other features of this application will be best understood from the following specification and drawings, the following of which is a brief description.

### BRIEF DESCRIPTION OF THE DRAWINGS

The drawings can be described as follows:

FIG. 1 illustrates an example gas turbine engine for use in a gas turbine engine.

FIG. 2 illustrates a known bracket.

FIG. 3 illustrates an example bracket having a formed gusset.

FIG. 4 illustrates a complete bracket assembly.

FIG. 5 illustrates another view of the complete bracket assembly from FIG. 4.

FIG. 6 illustrates another example of a bracket having a formed gusset.

### DETAILED DESCRIPTION

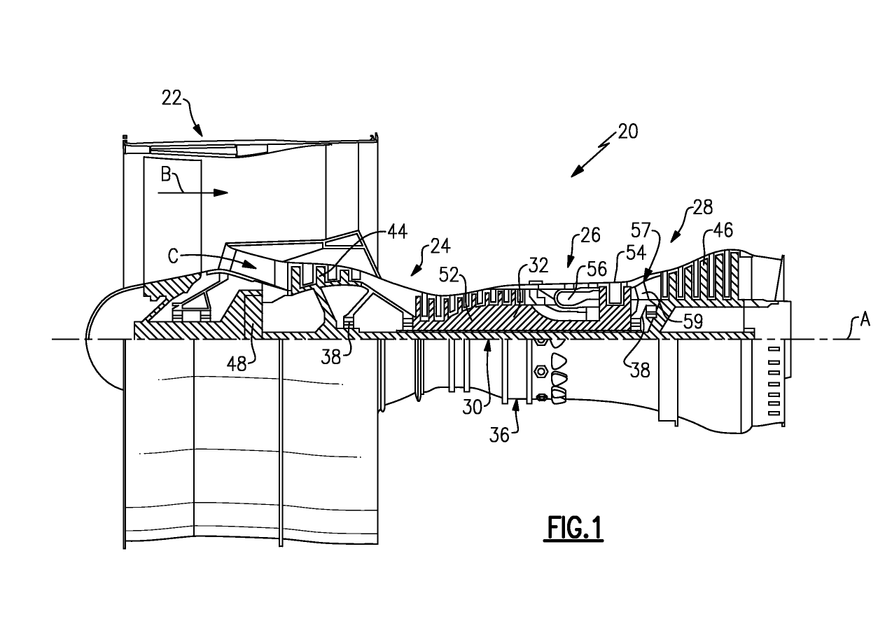

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flowpath B while the compressor section 24 drives air along a core flowpath C for compression and communication into the combustor section 26 then expansion through the turbine section 28. Although depicted as a turbofan gas turbine engine in the disclosed non-limiting embodiment, it should be understood that the concepts described herein are not limited to use with turbofans as the teachings may be applied to other types of turbine engines including three-spool architectures.

The engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided.

The low speed spool 30 generally includes an inner shaft 40 that interconnects a fan 42, a low pressure compressor 44 and a low pressure turbine 46. The inner shaft 40 is connected to the fan 42 through a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path. The turbines 46, 54 rotationally drive the respective low speed spool 30 and high speed spool 32 in response to the expansion.

The engine 20 in one example is a high-bypass geared aircraft engine. In a further example, the engine 20 bypass ratio is greater than about six (6), with an example embodiment being greater than ten (10), the geared architecture 48 is an epicyclic gear train, such as a planetary gear system or other gear system, with a gear reduction ratio of greater than about 2.3 and the low pressure turbine 46 has a pressure ratio that is greater than about 5. In one disclosed embodiment, the engine 20 bypass ratio is greater than about ten (10:1), the fan diameter is significantly larger than that of the low pressure compressor 44, and the low pressure turbine 46 has a pressure ratio that is greater than about 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.5:1. It should be understood, however, that the above parameters are only exemplary of one embodiment of a geared architecture engine and that the present disclosure is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft, with the engine at its best fuel consumption—also known as “bucket cruise Thrust Specific Fuel Consumption (‘TSFC’)”—is the industry standard parameter of 1 bm of fuel being burned divided by 1 bf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]^{0.5}.

The “Low corrected fan tip speed” as disclosed herein according to one non-limiting embodiment is less than about 1150 ft/second.

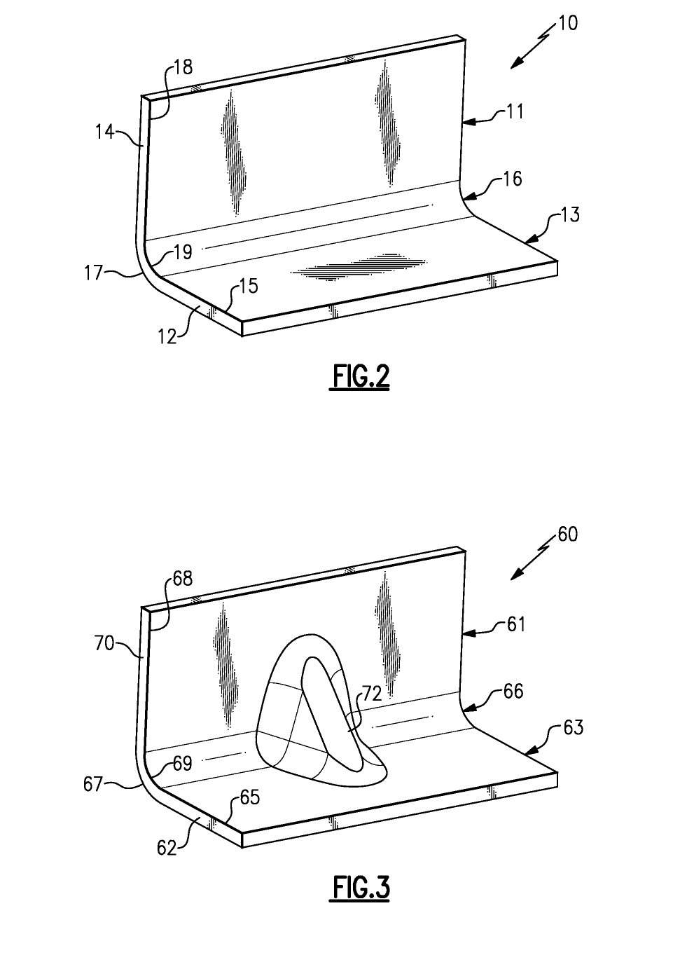

FIG. 2 shows a known bracket 10 in gas turbine engine 20. The bracket 10 includes a first wall 11 and a second wall 13. The first wall 11 has a first wall exterior 14 and a first wall interior 18. Similarly, the second wall 13 has a second wall interior 12 and a second wall exterior 15. An L-shaped bend 16 is positioned between the first wall 11 and the second wall 13. The bend consists of a bend interior 19 and a bend exterior 17.

FIG. 3 illustrates an example bracket 60 according to this disclosure. Unlike the bracket of FIG. 2, the bracket 60 has a gusset 72 formed integrally therewith. In the example of FIG. 3, the gusset 72 is formed within a first wall 61 and a second wall 63 of the bracket 60. The first wall 61 consists of a first wall exterior 70 and a first wall interior 68. The second wall 63 consists of a second wall interior 62 and a second wall exterior 65. The first wall 61 and the second wall 63 come together to form a bend 66. The bend consists of a bend interior 69 and a bend exterior 67.

FIG. 3 specifically illustrates the gusset 72 such that the gusset 72 is triangular in shape. The gusset 72 is a triangular shaped projection formed within the bend interior 69 of the bracket 60 to stiffen the bracket 60. The gusset 72 is formed within the first wall interior 68 of the first wall 61 and the second wall interior 62 of the second wall 63. Further, the gusset 72 protrudes from the first wall interior 68 and the second wall interior 62. Further still, the gusset 72 correspondently depresses the second wall exterior 65 and the first wall exterior 68 of the bracket 60. The gusset 72 and the bracket 60 are formed from one piece of metal. As an example, the bracket 60 consists of thin sheet metal. In one example, the gusset 72 is stamped into the bracket 60. In yet another example, the gusset 72 is integrally molded to the bracket 60.

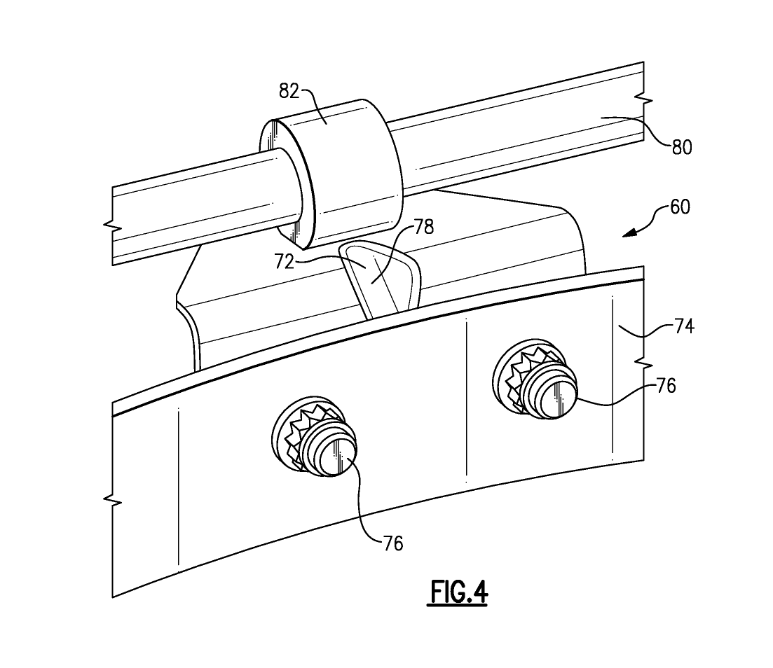

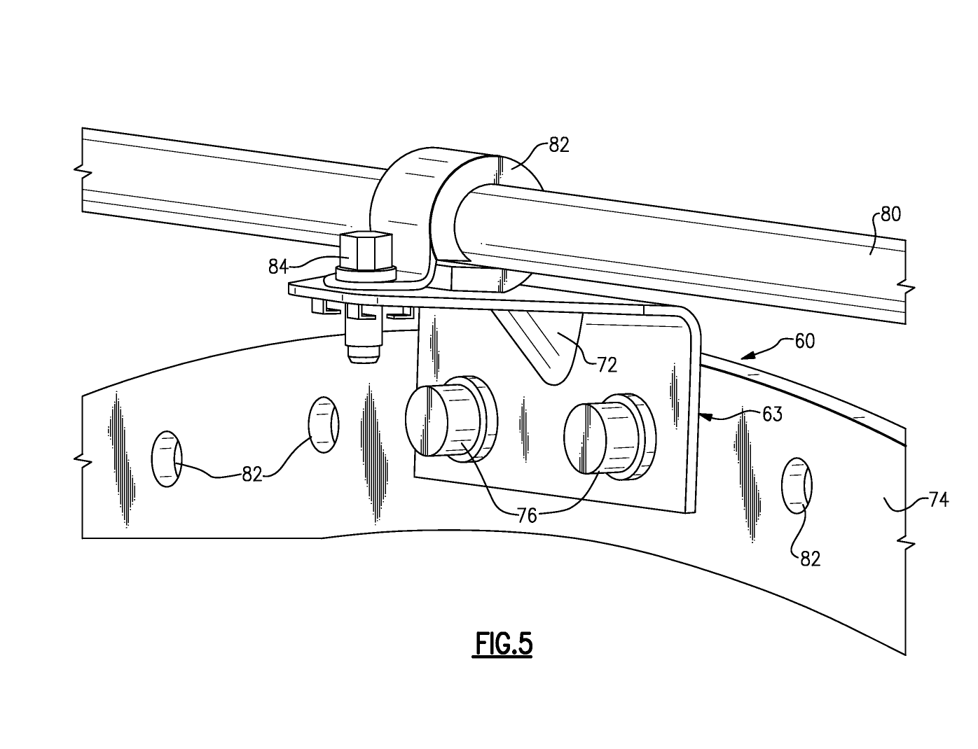

FIG. 4 is an example bracket assembly. In the example, the bracket 60 is fastened to a communicating member 80 via a mount 82. The bracket 60 is mounted to a static engine structure 74 by fastening members 76. In one example, the communicating member 80 is a fluid tube. In another example, the communicating member 80 is a wire. Other example communicating members includes valves and sensors.

One skilled in the art could select an appropriate fastener. Example fasteners include: a nut plate, a stud, or a spacer. In one example, fastening member 76 is welded into the static engine structure 74. In another example, fastening member 76 is riveted into static engine structure 74.

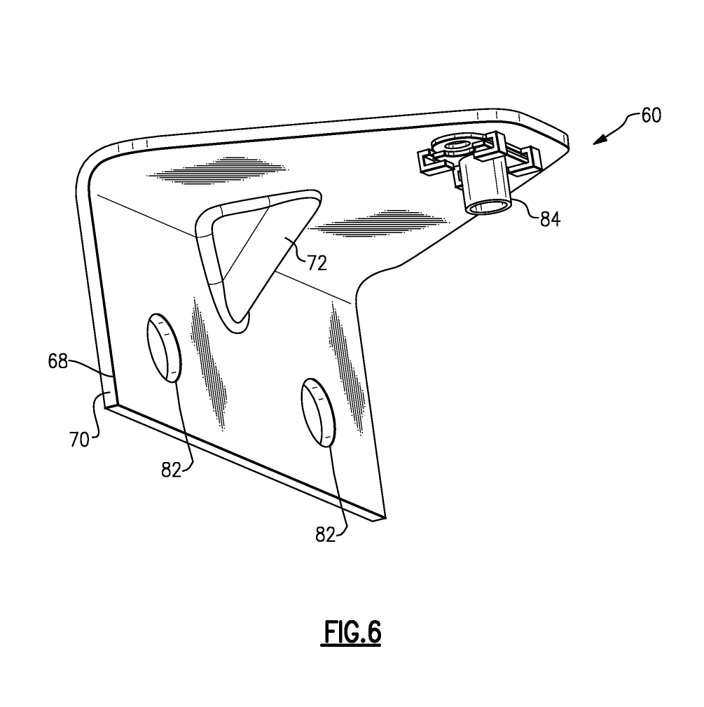

As shown in FIG. 5, the bracket 60 is mounted to a communication member 80 by use of a mount 82. The bracket 60 is mounted to the communication member 80 via a fastening mechanism 84 on the mount 82.

FIG. 5 specifically illustrates an example where the fastening mechanism 84 is a nut plate, however other types of fastening elements could be used. A nut plate is a stamped sheet metal nut that has an extended flat base for use of being secured to a surface. In one example, the fastening mechanism 84 is a captive nut plate. A captive nut plate is a self-retaining nut plate wherein the nut plate is fixed in the mount 82. The bracket 60 is mounted to a static engine structure 74 by attachment of a fastening member 76. The static engine structure 74 is parallel to the second wall 63 of the bracket 60. The static engine structure 74 includes a plurality of openings 82 for mounting.

FIG. 6 is a more detailed drawing of FIG. 3. FIG. 6 shows openings 82 in bracket 60 to provide mounting. In one example, the openings 82 may provide mounting to a static engine structure 74. The bracket 60 includes a fastening mechanism 84. In one example, the fastening mechanism 84 is a captive nut plate.

The above described bracket 60 provides a mounting assembly strengthened by integrally molding or stamping the bracket 60 with a gusset 72. In either case, the bracket 60 can be formed inexpensively and efficiently since it is made of one piece of material.

A worker of ordinary skill in this art would recognize that certain modifications would come within the scope of this disclosure. For that reason, the following claims should be studied to determine the true scope and content of this disclosure.

1. A bracket mount assembly for use in a gas turbine engine comprising:
a communicating member;
a mount;
a bracket to be supported by a static engine structure, the bracket mounted to the communicating member by way of the mount, the bracket including a first wall and a second wall, the bracket including a bend between the first wall and the second wall, the bend including a gusset, the gusset providing a depression in the bend, and the gusset and the bracket are made from a single piece of metal.

2. The bracket mount assembly according to claim 1, wherein the first wall includes openings, and wherein fastening members are provided through the openings to support the bracket relative the bracket.

3. The bracket mount assembly according to claim 1, wherein the mount is attached to the upper surface of the first wall.

4. The bracket mount assembly according to claim 1, wherein the gusset further provides the depression in an inner face first wall and an inner face second wall.

5. The gas turbine engine according to claim 1, wherein the static engine structure is parallel to the second wall.

6. The bracket mount assembly according to claim 1, wherein the gusset further provides a corresponding projection in an outer face first wall and an outer face second wall.

7. The bracket mount assembly according to claim 1, wherein the communicating member is a wire.

8. The bracket mount assembly according to claim 1, wherein the communicating member is one of a fluid tube, a valve, and a sensor.

9. The bracket mount assembly according to claim 1, wherein the communicating member is attached by use of a captive nut plate.

10. The bracket mount assembly according to claim 1, wherein the gusset is stamped into the bracket.

11. A gas turbine engine comprising:
a communicating member;
a mount;
a static engine structure;
a bracket supported by the static engine structure, the communicating member mounted to the bracket by way of the mount, the bracket including a first wall and a second wall, the bracket including a bend between the first wall and the second wall, the bend including a gusset, the gusset providing a depression in the bend, and the gusset and the bracket are made from a single piece of metal.

12. The gas turbine engine according to claim 11, wherein the first wall includes openings, and wherein fastening members are provided through the openings to support the bracket relative the bracket.

13. The gas turbine engine according to claim 11, wherein the mount is attached to the upper surface of the first wall.

14. The gas turbine engine according to claim 11, wherein the static engine structure is parallel to the second wall.

15. The gas turbine engine according to claim 11, wherein the formation of the gusset provides the depression in an inner face first wall and an inner face second wall.

16. The gas turbine engine according to claim 11, wherein the formation of the gusset further provides a corresponding projection in an outer face first wall and an outer face second wall.

17. The gas turbine engine according to claim 11, wherein the communicating member is a wire.

18. The gas turbine engine according to claim 11, wherein the communicating member is one of a fluid tube, a valve, and a sensor.

19. The gas turbine engine according to claim 11, wherein the mount is a captive nut plate.

20. The gas turbine engine according to claim 11, wherein the gusset is stamped into the bracket.
